(19) United States
(12) Patent Application Publication
(10) Pub. No.: US 2026/0038866 A1
(43) Pub. Date: Feb. 5, 2026

(54) COLUMNAR SECONDARY BATTERY AND ELECTRONIC DEVICE

(71) Applicant: Xiamen Ampace Technology Limited, Xiamen (CN)

(72) Inventor: Chunhua LI, Ningde (CN)

(73) Assignee: Xiamen Ampace Technology Limited, Xiamen (CN)

(21) Appl. No.: 19/288,023

(22) Filed: Aug. 1, 2025

(30) Foreign Application Priority Data
Aug. 2, 2024 (CN) 202411059757.8

(51) Int. Cl. H01M 10/04; H01M 4/02; H01M 10/0525

(52) U.S. Cl. CPC H01M 10/0422; H01M 10/0431; H01M 2004/021; H01M 10/0525

(57) ABSTRACT

A columnar secondary battery includes an electrode assembly. The electrode assembly includes an electrode plate. The electrode plate includes a current collector and a first material layer. The first material layer is located on a surface of the current collector facing away from a winding center of the electrode assembly. Along a length direction of the electrode plate and along a winding direction of the electrode assembly, the first material layer includes a first section and a second section connected sequentially. Based on a length of the first material layer, a length of the first section accounts for a proportion of L, 2%≤L≤20%. A plurality of protrusions are formed on a surface of the first section alone on the electrode plate.

### CROSS-REFERENCE TO RELATED APPLICATIONS

This application claims the priority of Chinese Application No. 202411059757.8, filed on Aug. 2, 2024, the contents of which is incorporated herein by reference in its entirety.

### TECHNICAL FIELD

This application relates to the field of electrochemical technology, and in particular, to a columnar secondary battery and an electronic device.

### BACKGROUND

Columnar secondary batteries, such as a columnar lithium-ion battery, are applied to a plurality of high-rate discharge systems (in which the discharge rate is greater than 3C, for example), and are widely used in the field of consumer electronics by virtue of a high specific energy, a high working voltage, a low self-discharge rate, a small size, a light weight, and other characteristics.

Currently, the design of high-power columnar lithium-ion batteries is typically a full-tab design, in which a positive tab and a negative tab extend from opposite directions and are prepared using a full-tab smooth-out flattening technology. However, in a later stage of cycling of a full-tab columnar lithium-ion battery, an electrode plate expands, and is prone to cause the electrode plate at an inner turn of an electrode assembly of the lithium-ion battery to deform inward. Consequently, a distance between a positive electrode plate and a negative electrode plate is increased, and the electrochemical impedance of the lithium-ion battery during charge-and-discharge cycling is increased, thereby increasing the risk of lithium plating of the lithium-ion battery, and deteriorating the cycle performance.

### SUMMARY

An objective of this application is to provide a columnar secondary battery and an electronic device to reduce the risk of lithium plating of the columnar secondary battery caused by inward deformation of an electrode plate at an inner turn of an electrode assembly due to expansion of the electrode plate in a later stage of cycling, so as to improve the cycle performance of the secondary battery.

It is hereby noted that in the subject matter hereof, this application is construed by using a lithium-ion battery as an example of the columnar secondary battery, but the columnar secondary battery of this application is not limited to the lithium-ion battery. Specific technical solutions are as follows:

A first aspect of this application provides a columnar secondary battery. The columnar secondary battery includes an electrode assembly. The electrode assembly includes an electrode plate. The electrode plate includes a current collector and a first material layer. The first material layer is located on a surface of the current collector facing away from a winding center of the electrode assembly. Along a length direction of the electrode plate unwound and along a winding direction of the electrode assembly, the first material layer includes a first section and a second section connected sequentially. Based on a length of the first material layer, a length of the first section accounts for a proportion of L, satisfying: 2%≤ L≤20%, and optionally, 5%≤L≤18%. A plurality of protrusions are formed on a surface of the first section alone on the electrode plate. By disposing the protrusions on the surface of the first section alone and controlling the length proportion of the first section to fall within the above range, this application can effectively reduce the risk of lithium plating of the columnar secondary battery caused by the inward deformation of the electrode plate at an inner turn of the electrode assembly due to expansion of the electrode plate in the later stage of cycling. By disposing protrusions in a regular pattern, the distance between a positive electrode plate and a negative electrode plate as well as the distance between electrode plate layers can be designed to fall within an appropriate range during charging and discharging. Therefore, the electrochemical impedance of the secondary battery is low, thereby reducing the risk of lithium plating and improving the cycle performance of the secondary battery.

In one or more embodiments, along a thickness direction of the electrode plate, an average height of the plurality of protrusions is h₁ μm, and a sum of thicknesses of the first material layer and the current collector is h₀ μm, satisfying: 2%≤h₁/h₀×100%≤40%, and optionally 10%≤h₁/h₀×100%≤30%, and 35≤h₀≤70. By controlling the values of h₁/h₀×100% and h₀ to fall within the above ranges, this application reduces the risk of lithium plating of the columnar secondary battery caused by the inward deformation of the electrode plate at an inner turn of the electrode assembly due to expansion of the electrode plate in the later stage of cycling. In this way, the reserved space is moderate, and the electrochemical impedance of the secondary battery during charging and discharging is small, thereby reducing the risk of lithium plating and improving the cycle performance of the secondary battery.

In one or more embodiments, along a thickness direction of the electrode plate, every protrusion is projected onto the first material layer to form a projection. Based on a projected area of the first section on the current collector, a sum of projected areas of the plurality of protrusions on the first material layer accounts for a proportion of S, satisfying: 15%<<70%, and optionally 25%<<60%. By controlling the sum of projected areas of the plurality of protrusions on the first material layer to account for a proportion of S falling within the above range, this application reduces the risk of lithium plating of the columnar secondary battery caused by the inward deformation of the electrode plate at an inner turn of the electrode assembly due to expansion of the electrode plate in the later stage of cycling, improves the cycle performance of the secondary battery, and ensures a desirable energy density of the secondary battery at the same time.

In one or more embodiments, along the length direction of the electrode plate unwound, a spacing between two adjacent protrusions is A mm, satisfying: 0.2≤A≤10, and optionally 1.5≤A≤5. By controlling the spacing A between two adjacent protrusions to fall within the above range, this application reduces the risk of lithium plating of the columnar secondary battery caused by the inward deformation of the electrode plate at an inner turn of the electrode assembly due to expansion of the electrode plate in the later stage of cycling, and improves the cycle performance of the secondary battery.

In one or more embodiments, along the length direction of the electrode plate unwound, spacings between any two adjacent protrusions are equal.

In one or more embodiments, a diameter of a maximum circumcircle of an outer contour of the projection of a single protrusion is D mm, satisfying: 0.5≤D≤10, and optionally 2≤D≤6. By controlling the diameter D of the maximum circumcircle of the outer contour of the projection of a single protrusion to fall within the above range, this application reduces the risk of an increase in the electrochemical impedance caused by an increase in side reactions due to local concentration of an electrolyte solution, and also reduces the risk of lithium plating of the columnar secondary battery caused by the inward deformation of the electrode plate at an inner turn of the electrode assembly due to expansion of the electrode plate in the later stage of cycling, thereby improving the cycle performance of the secondary battery.

In one or more embodiments, the electrode plate further includes a second material layer. The second material layer is located on a surface of the current collector facing the winding center of the electrode assembly. A surface of the second material layer is provided with a plurality of first recesses toward the first material layer. In one or more embodiments, the current collector is provided with a plurality of second recesses toward the first material layer. In one or more embodiments, at least a part of the first recesses correspond to a part of the protrusions; and/or at least a part of the second recesses correspond to a part of the protrusions. The above arrangement improves the operability of forming protrusions, the first recesses, and the second recesses on the first section, improves the infiltration performance of the electrolyte solution for the electrode plate, further reduces the risk of lithium plating of the columnar secondary battery caused by the inward deformation of the electrode plate at an inner turn of the electrode assembly due to expansion of the electrode plate in the later stage of cycling, and improves the cycle performance of the secondary battery while ensuring manufacturability in mass production.

In one or more embodiments, the electrode plate is a positive electrode plate.

A second aspect of this application provides an electronic device. The electronic device includes the columnar secondary battery disclosed in any one of the preceding embodiments. The columnar secondary battery of this application exhibits good cycle performance. Therefore, the electronic device of this application possesses a relatively long service life.

Beneficial effects of some embodiments of this application are as follows:

By disposing the protrusions on the first section and controlling the length proportion of the first section to fall within the range specified herein, embodiments of this application can reduce the risk of lithium plating of the columnar secondary battery caused by the inward deformation of the electrode plate at an inner turn of the electrode assembly due to expansion of the electrode plate in the later stage of cycling. Such an arrangement makes the distance between a positive electrode plate and a negative electrode plate keep within an appropriate range, and makes the electrochemical impedance of the secondary battery relatively small, thereby improving the cycle performance of the columnar secondary battery and reducing the lithium plating risk.

Definitely, a single product or method in which the technical solution of this application is implemented does not necessarily achieve all of the above advantages concurrently.

### BRIEF DESCRIPTION OF DRAWINGS

To describe the technical solutions in some embodiments of this application or the prior art more clearly, the following outlines the drawings to be used in the description of some embodiments of this application or the prior art. Evidently, the drawings outlined below merely illustrate some embodiments of this application, and a person of ordinary skill in the art may derive other embodiments from the drawings.

FIG. 1 is a computed tomography (CT) scan image of inward deformation of an electrode plate at an inner turn in a later stage of cycling of a columnar lithium-ion battery in the prior art;

FIG. 2 is a schematic diagram of a jelly-roll structure of an electrode assembly according to an embodiment of this application;

FIG. 3 is a partial front view of a positive electrode plate of the electrode assembly shown in FIG. 2 after the electrode assembly is unwound; and

FIG. 4 is a cross-sectional view of the positive electrode plate shown in FIG. 3 sectioned along a P-P direction.

List of reference signs: electrode assembly 001; positive electrode plate 10; positive current collector 11; first positive electrode material layer 12; second positive electrode material layer 13; negative electrode plate 20; negative current collector 21; first negative electrode material layer 22; second negative electrode material layer 23; separator 30; protrusion 121; first recess 131; second recess 111

### DETAILED DESCRIPTION

The following describes the technical solutions in some embodiments of this application clearly in detail with reference to the drawings appended hereto. Evidently, the described embodiments are merely a part of but not all of the embodiments of this application. All other embodiments derived by a person skilled in the art based on this application still fall within the protection scope of this application.

It is hereby noted that in specific embodiments of this application, this application is construed by using a lithium-ion battery as an example of the columnar secondary battery, but the columnar secondary battery of this application is not limited to the lithium-ion battery.

In the prior art, in a columnar secondary battery such as a columnar lithium-ion battery, an electrode plate expands in the later stage of cycling. Especially when a negative electrode plate includes a silicon-containing negative active material, the negative electrode plate expands. As shown in FIG. 1, the expansion causes the electrode plate at inner turns of the electrode assembly to deform inward. In this case, the distance between the positive electrode plate and the negative electrode plate is further increased. The impedance of the lithium-ion battery increases accordingly during charging and discharging, thereby further increasing the risk of lithium plating of the lithium-ion battery, and also affecting the cycle performance of the lithium-ion battery. In view of the above situation, this application provides a columnar secondary battery and an electronic device to reduce the risk of lithium plating of the columnar secondary battery caused by inward deformation of an electrode plate at an inner turn of an electrode assembly due to expansion of the electrode plate in a later stage of cycling, so as to improve the cycle performance of the secondary battery.

A first aspect of this application provides a columnar secondary battery. The columnar secondary battery includes an electrode assembly. The electrode assembly includes an electrode plate. The electrode plate includes a current collector and a first material layer. The first material layer is located on a surface of the current collector facing away from a winding center of the electrode assembly. Along a length direction of the electrode plate unwound and along a winding direction of the electrode assembly, the first material layer includes a first section and a second section connected sequentially. Based on a length of the first material layer, a length of the first section accounts for a proportion of L, satisfying: 2%<L≤20%, and optionally, 5%≤L≤18%. For example, the value of L may be 2%, 3%, 4%, 5%, 6%, 7%, 8%, 9%, 10%, 11%, 12%, 13%, 14%, 15%, 16%, 17%, 18%, 19%, 20%, or a value falling within a range formed by any two thereof. A plurality of protrusions are formed on a surface of the first section alone on the electrode plate.

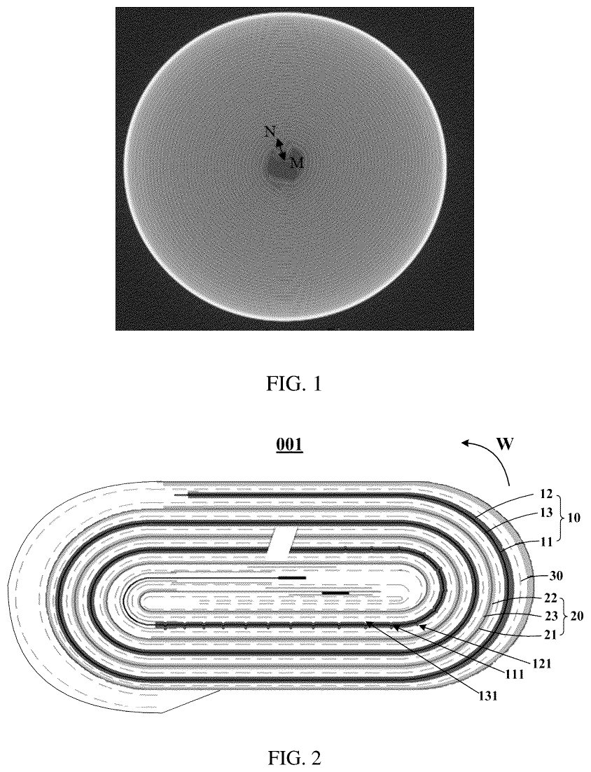

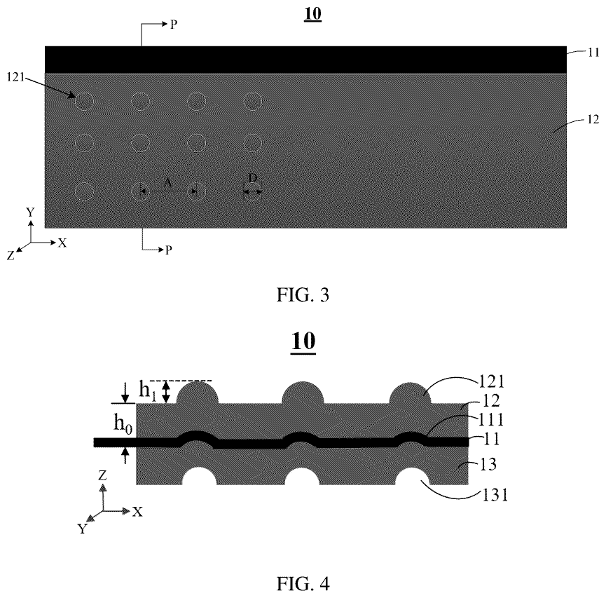

In this application, the electrode plate may be a positive electrode plate or a negative electrode plate. It is defined that in an unwound state of the electrode assembly, the length direction of the electrode assembly is an X direction, the width direction of the electrode assembly is a Y direction, and the thickness direction of the electrode assembly is a Z direction. Understandably, in an unwound state, the length direction, width direction, and thickness direction of the negative electrode plate, the positive electrode plate, and the separator are the same as the length direction, width direction, and thickness direction of the electrode assembly, respectively, and the winding direction of the electrode assembly is a W direction. In an example, as shown in FIG. 2 and FIG. 3, the electrode assembly 001 includes a positive electrode plate 10, a negative electrode plate 20, and a separator 30. The positive electrode plate 10 includes a positive current collector 11 and a first positive electrode material layer 12. The negative electrode plate 20 includes a negative current collector 21 and a first negative electrode material layer 22. Along the length direction (X direction) of the positive electrode plate 10 unwound, and along the winding direction (W direction) of the electrode assembly 001, the first positive electrode material layer 12 includes a first section (not shown in the figure) and a second section (not shown in the figure) connected sequentially. A plurality of protrusions 121 are formed on a surface of the first section alone on the positive electrode plate 10.

When the length proportion L of the first section is excessively low, for example, less than a lower limit specified herein, that is, when the length proportion of the second section is excessively high, the area of the protrusions on the electrode plate is excessively small, thereby resulting in a small expansion space reserved, and failing to effectively alleviate the inward deformation of the electrode plate at the inner turns of the electrode assembly due to expansion of the electrode plate in the later stage of cycling. Consequently, the distance between the positive electrode plate and the negative electrode plate is large, and the impedance of the secondary battery increases during charging and discharging. The secondary battery is at high risk of lithium plating, and the cycle performance of the secondary battery is inferior. When the length proportion L of the first section is excessively high, for example, higher than an upper limit specified herein, that is, when the length proportion of the second section is excessively low, the area of the protrusions on the electrode plate is excessively large, thereby resulting in a large expansion space reserved, and being prone to the phenomenon of electrolyte flow discontinuity between some layers of the electrode plate. Consequently, the electrochemical impedance of the secondary battery increases, the risk of lithium plating of the secondary battery increases, and the cycle performance of the secondary battery is inferior. This application provides protrusions on the surface of the first section alone and controls the length proportion of the first section to fall within the above range, thereby reserving an expansion space at the inner turns of the electrode assembly, effectively reducing the risk of lithium plating of the columnar secondary battery caused by the inward deformation of the electrode plate at the inner turns of the electrode assembly due to expansion of the electrode plate in the later stage of cycling. In addition, the reserved expansion space is moderate, and the distance between the positive electrode plate and the negative electrode plate as well as the distance between different layers of the electrode plate during charging and discharging are designed to fall within an appropriate range. Therefore, the electrochemical impedance of the secondary battery is small, thereby reducing the risk of lithium plating, improving the cycle performance of the secondary battery, and endowing the columnar secondary battery of this application with good cycle performance. It is hereby noted that the “surface” in “the first material layer is located on a surface of the current collector facing away from the winding center of the electrode assembly” may be the entire surface region of the current collector, or a partial surface region of the current collector, without being particularly limited herein, as long as the objectives of this application can be achieved.

In one or more embodiments, based on the length of the first material layer, the length proportion of the second section is L′, satisfying: 80%≤L′≤98%. For example, the value of L′ may be 80%, 82%, 85%, 88%, 90%, 92%, 95%, 98%, or a value falling within a range formed by any two thereof. By controlling the length proportion L′ of the second section to fall within the above range, this application reserves an expansion space at the inner turns of the electrode assembly, and reduces the risk of lithium plating of the columnar secondary battery caused by the inward deformation of the electrode plate at the inner turns of the electrode assembly due to expansion of the electrode plate in the later stage of cycling. In addition, the distance between the positive electrode plate and the negative electrode plate as well as the distance between different layers of the electrode plate during charging and discharging are made to fall within an appropriate range, and therefore, the electrochemical impedance of the secondary battery is low, thereby improving the cycle performance of the secondary battery.

In one or more embodiments, along the thickness direction of the electrode plate, an average height of the plurality of protrusions is h₁ μm, and a sum of thicknesses of the first material layer and the current collector is h₀ μm. As shown in FIG. 4, along the thickness direction (Z direction) of the positive electrode plate 10, the average height of the plurality of protrusions 121 is h₁ μm, and a sum of thicknesses of the first positive electrode material layer 12 and the positive current collector 11 is h₀ μm, satisfying: 2%≤h₁/h₀×100%≤40%, and optionally 10%≤h₁/h₀×100%≤30%, and 35≤h₀≤70. For example, the value of h₁/h₀×100% may be 2%, 5%, 8%, 10%, 12%, 15%, 18%, 20%, 22%, 25%, 28%, 30%, 32%, 35%, 38%, 40%, or a value falling within a range formed by any two thereof. By controlling the values of h₁/h₀×100% and h₀ to fall within the above range, this application reserves an expansion space at the inner turns of the electrode assembly, and reduces the risk of lithium plating of the columnar secondary battery caused by the inward deformation of the electrode plate at the inner turns of the electrode assembly due to expansion of the electrode plate in the later stage of cycling. In addition, the reserved space is moderate, a close fit can be implemented between the positive electrode plate and the negative electrode plate and between different layers of the electrode plate during charging and discharging, and the electrochemical impedance of the secondary battery during charging and discharging is low, thereby improving the cycle performance of the secondary battery. In this application, the thickness of the first material layer may be controlled by means known to a person skilled in the art. For example, when a slurry is applied onto the surface of a current collector, on the basis that the solid content of the slurry is constant, the thickness of the first material layer can be increased by increasing the coating weight; and the thickness of the first material layer can be reduced by reducing the coating weight. Further, when the electrode is cold-pressed, the thickness of the first material layer can be reduced by increasing the cold-pressing pressure, and the thickness of the first material layer can be increased by reducing the cold-pressing pressure. The method for controlling the thickness of the current collector is not particularly limited herein, as long as the objectives of this application can be achieved. For example, commercially available current collectors of different thicknesses may be selected, and the thicknesses of the current collectors may be determined with reference to the test method described in the section headed “Test of h₁, h₀, S, A, and D” in this application, and then the current collector of the desired thickness is selected. In one or more embodiments, along the thickness direction of the electrode plate, the thickness of the current collector may be 10 μm to 15 μm.

In one or more embodiments, 0.7≤h_{1≤28}. For example, the value of h₁ may be 0.7, 0.8, 1, 3, 5, 8, 10, 12, 15, 18, 20, 22, 25, 28, or a value falling within a range formed by any two thereof. By controlling the value of h₁ to fall within the above range, this application reserves an expansion space at the inner turns of the electrode assembly, and reduces the risk of lithium plating of the columnar secondary battery caused by the inward deformation of the electrode plate at the inner turns of the electrode assembly due to expansion of the electrode plate in the later stage of cycling. In addition, the reserved space is moderate, a close fit can be implemented between the positive electrode plate and the negative electrode plate and between different layers of the electrode plate during charging and discharging, and the electrochemical impedance of the secondary battery during charging and discharging is low, thereby improving the cycle performance of the secondary battery.

In one or more embodiments, along a thickness direction of the electrode plate, every protrusion is projected onto the first material layer to form a projection. Based on a projected area of the first section on the current collector, a sum of projected areas of the plurality of protrusions on the first material layer accounts for a proportion of S, satisfying: 15%≤S≤70%, and optionally 25%≤S≤60%. For example, the value of S may be 15%, 18%, 20%, 22%, 25%, 28%, 30%, 32%, 35%, 38%, 40%, 42%, 45%, 48%, 50%, 52%, 55%, 58%, 60%, 62%, 65%, 68%, 70%, or a value falling within a range formed by any two thereof. By controlling the proportion S of the sum of projected areas of a plurality of protrusions on the first material layer to fall within the above range, this application reserves an expansion space at the inner turns of the electrode assembly, and reduces the risk of lithium plating of the columnar secondary battery caused by the inward deformation of the electrode plate at the inner turns of the electrode assembly due to expansion of the electrode plate in the later stage of cycling. In addition, the reserved space is moderate, a close fit can be implemented between the positive electrode plate and the negative electrode plate and between different layers of the electrode plate during charging and discharging, and the electrochemical impedance of the secondary battery during charging and discharging is low, thereby reducing the risk of lithium plating and improving the cycle performance of the secondary battery while ensuring a desirable energy density of the secondary battery.

In one or more embodiments, along the length direction of the electrode plate unwound, the spacing between two adjacent protrusions is A mm. As shown in FIG. 3, along the length direction (X direction) of the positive electrode plate 10 unwound, the spacing between two adjacent protrusions 121 is A mm, satisfying: 0.2≤A≤10, and optionally 1.5≤ A≤5. For example, the value of A may be 0.2, 0.5, 0.8, 1, 1.2, 1.5, 1.8, 2, 2.2, 2.5, 2.8, 3, 3.2, 3.5, 3.8, 4, 4.2, 4.5, 4.8, 5, 5.2, 5.5, 5.8, 6, 6.2, 6.5, 6.8, 7, 7.2, 7.5, 7.8, 8, 8.2, 8.5, 8.8, 9, 9.2, 9.5, 9.8, 10, or a value falling within a range formed by any two thereof. By controlling the spacing A between two adjacent protrusions to fall within the above range, this application reduces the difficulty of processing the electrode plate during processing, reduces the risk of a decline in the energy density of the secondary battery caused by the loss of an active material due to excessive powder shedding during the processing of the electrode plate, and achieves uniformity of pore distribution of the electrode plate, thereby facilitating circulation of the electrolyte solution on the electrode plate and improving the infiltration effect of the electrolyte solution for the electrode plate. This reduces the risk of lithium plating of the columnar secondary battery caused by the inward deformation of the electrode plate at the inner turns of the electrode assembly due to expansion of the electrode plate in the later stage of cycling. In addition, the reserved space is moderate, and a close fit can be implemented between the positive electrode plate and the negative electrode plate and between different layers of the electrode plate during charging and discharging, and the electrochemical impedance of the secondary battery during charging and discharging is low, thereby reducing the risk of lithium plating and improving the cycle performance of the secondary battery. In this application, the spacing between two adjacent protrusions means a distance between geometric centers of the two adjacent protrusions along the length direction of the electrode plate unwound.

In one or more embodiments, along the length direction of the electrode plate unwound, spacings between any two adjacent protrusions are equal. The above arrangement improves the operability of forming protrusions on the first section, reduces the risk of lithium plating of the columnar secondary battery caused by the inward deformation of the electrode plate at an inner turn of the electrode assembly due to expansion of the electrode plate in the later stage of cycling, and improves the cycle performance of the columnar secondary battery while ensuring manufacturability in mass production.

In one or more embodiments, along the thickness direction of the electrode plate, a plurality of protrusions are located on the same side of the electrode plate. The above arrangement improves the operability of forming protrusions on the first section, alleviates the inward deformation of the electrode plate on the inner layers, reduces the risk of lithium plating of the columnar secondary battery caused by the inward deformation of the electrode plate at an inner turn of the electrode assembly due to expansion of the electrode plate in the later stage of cycling, and improves the cycle performance of the columnar secondary battery while ensuring manufacturability in mass production.

In one or more embodiments, the diameter of a maximum circumcircle of the outer contour of the projection of a single protrusion is D mm. As shown in FIG. 3, the diameter of the maximum circumcircle of the outer contour of the projection of a single protrusion 121 is D mm, satisfying: 0.5≤D≤10, and optionally 2≤D≤6. For example, the value of D may be 0.5, 0.8, 1, 1.2, 1.5, 1.8, 2, 2.2, 2.5, 2.8, 3, 3.2, 3.5, 3.8, 4, 4.2, 4.5, 4.8, 5, 5.2, 5.5, 5.8, 6, 6.2, 6.5, 6.8, 7, 7.2, 7.5, 7.8, 8, 8.2, 8.5, 8.8, 9, 9.2, 9.5, 9.8, 10, or a value falling within a range formed by any two thereof. By controlling the diameter D of the maximum circumcircle of the outer contour of the projection of a single protrusion to fall within the above range, this application reduces the risk of a decrease in the reserved expansion space caused by a collapse of the protrusions during preparation or cycling, and makes the reserved space moderate. Such a setting can effectively alleviate the risk of the inward deformation of the electrode plate at the inner turns of the electrode assembly in the later stage of cycling. In addition, such a setting achieves a moderate size of the dent on the surface of the electrode plate facing the winding center of the electrode assembly, reduces the risk of an increase in the electrochemical impedance caused by an increase in side reactions due to local concentration of an electrolyte solution, and also reduces the risk of lithium plating of the columnar secondary battery caused by the inward deformation of the electrode plate at an inner turn of the electrode assembly due to expansion of the electrode plate in the later stage of cycling, thereby improving the cycle performance of the secondary battery. The shape of the projection of a single protrusion is not particularly limited herein, as long as the objectives of this application can be achieved. For example, the shape of the projection of a single protrusion may be at least one of a triangle, an arcuate shape (the area of the arcuate shape is smaller than the area of a semicircle with the same radius), a semicircle, a rectangle, a trapezoid, a square, or a pentagon or a polygon with more sides.

In one or more embodiments, the protrusions are distributed in a dotted pattern on the surface of the first section. In one or more embodiments, the protrusions are distributed in a matrix pattern on the surface of the first section. In one or more embodiments, when the protrusions are distributed in a matrix pattern on the surface of the first section, the spacings between adjacent rows are equal along the width direction of the electrode plate unwound. The number of rows of the protrusions is not particularly limited herein, and may be set by a person skilled in the art depending on the specification of the electrode plate, as long as the objectives of this application can be achieved.

In one or more embodiments, the electrode plate further includes a second material layer. The second material layer is located on a surface of the current collector facing the winding center of the electrode assembly. A surface of the second material layer is provided with a plurality of first recesses toward the first material layer. As shown in FIG. 2 and FIG. 4, the positive electrode plate 10 further includes a second positive electrode material layer 13. The second positive electrode material layer 13 is located on a surface of the positive current collector 11 facing the winding center of the electrode assembly 001. A surface of the second positive electrode material layer 13 is provided with a plurality of first recesses 131 toward the first positive electrode material layer 12. The above arrangement improves the operability of forming protrusions and the first recesses on the first section, improves the infiltration performance of the electrolyte solution for the electrode plate, further reduces the risk of lithium plating of the columnar secondary battery caused by the inward deformation of the electrode plate at an inner turn of the electrode assembly due to expansion of the electrode plate in the later stage of cycling, and improves the cycle performance of the secondary battery while ensuring manufacturability in mass production. It is hereby noted that the “surface” in “the second material layer is located on a surface of the current collector facing the winding center of the electrode assembly” may be the entire surface region of the current collector, or a partial surface region of the current collector, without being particularly limited herein, as long as the objectives of this application can be achieved.

In one or more embodiments, the current collector is provided with a plurality of second recesses toward the first material layer. The above arrangement improves the operability of forming protrusions and the second recesses on the first section, further reduces the risk of lithium plating of the columnar secondary battery caused by the inward deformation of the electrode plate at an inner turn of the electrode assembly due to expansion of the electrode plate in the later stage of cycling, and improves the cycle performance of the secondary battery while ensuring manufacturability in mass production.

In one or more embodiments, at least a part of the first recesses correspond to a part of the protrusions; and/or at least a part of the second recesses correspond to a part of the protrusions. The above arrangement improves the operability of forming protrusions, the first recesses and/or the second recesses on the first section, further reduces the risk of lithium plating of the columnar secondary battery caused by the inward deformation of the electrode plate at an inner turn of the electrode assembly due to expansion of the electrode plate in the later stage of cycling, and improves the cycle performance of the secondary battery while ensuring manufacturability in mass production.

In one or more embodiments, the electrode plate is a positive electrode plate. When the electrode plate is a positive electrode plate, this application further reduces the risk of lithium plating of the columnar secondary battery caused by the inward deformation of the electrode plate at the inner turns of the electrode assembly due to expansion of the electrode plate in the later stage of cycling. In addition, the reserved space is moderate, the distance between the positive electrode plate and the negative electrode plate as well as the distance between different layers of the electrode plate during charging and discharging are made to fall within an appropriate range, and therefore, the electrochemical impedance of the secondary battery is low, thereby further improving the cycle performance of the secondary battery.

In this application, when the electrode plate is a positive electrode plate, the positive current collector is not particularly limited herein, as long as the objectives of this application can be achieved. For example, the positive current collector may include aluminum foil, aluminum alloy foil, a composite current collector (such as an aluminum carbon composite current collector), or the like. In this case, both the first material layer and the second material layer are positive electrode material layers. The positive electrode material layer of this application includes a positive active material. The type of the positive active material is not particularly limited herein, as long as the objectives of this application can be achieved. For example, the positive active material may include at least one of lithium nickel cobalt manganese oxide (LiNi_{0.90}Co_{0.05}Mn_{0.05}O₂ (NCM955), NCM811, NCM622, NCM523, NCM111), lithium nickel cobalt aluminum oxide, lithium iron phosphate, a lithium-rich manganese-based material, lithium cobalt oxide (LiCoO₂), lithium manganese oxide, lithium manganese iron phosphate, lithium titanium oxide, or the like. In this application, the positive active material may further include a non-metal element. For example, the non-metal element includes at least one of fluorine, phosphorus, boron, chlorine, silicon, or sulfur. The thickness of the positive current collector is not particularly limited herein, as long as the objectives of this application can be achieved. In this application, the positive electrode material layer may further include a positive electrode binder and a conductive agent. The type of the positive electrode binder in the positive electrode material layer is not particularly limited herein, as long as the objectives of this application can be achieved. For example, the positive electrode binder may include, but is not limited to, at least one of polyvinylidene fluoride, poly(vinylidene fluoride-co-hexafluoropropylene), polyamide, polyacrylonitrile, polyacrylate ester, polyacrylic acid, polyacrylate salt, polyvinylpyrrolidone, polyvinyl ether, polymethylmethacrylate, polytetrafluoroethylene, or polyhexafluoropropylene. The type of the conductive agent in the positive electrode material layer is not particularly limited herein, as long as the objectives of this application can be achieved. For example, the conductive agent may include, but is not limited to, at least one of conductive carbon black (Super P), carbon nanotubes (CNTs), carbon fibers, flake graphite, Ketjen black, graphene, a metal material, or a conductive polymer. The carbon nanotubes may include, but are not limited to, single-walled carbon nanotubes and/or multi-walled carbon nanotubes. The carbon fibers may include, but are not limited to, vapor grown carbon fibers (VGCF) and/or carbon nanofibers. The metal material may include, but is not limited to, metal powder and/or metal fibers. Specifically, the metal may include, but is not limited to, at least one of copper, nickel, aluminum, or silver. The conductive polymer may include, but is not limited to, at least one of polyphenylene derivatives, polyaniline, polythiophene, polyacetylene, or polypyrrole. The mass ratio between the positive active material, the conductive agent, and the positive electrode binder in the positive electrode material layer is not particularly limited herein, and may be selected by a person skilled in the art as actually required, as long as the objectives of this application can be achieved.

In this application, when the electrode plate is a negative electrode plate, the negative current collector is not particularly limited herein, as long as the objectives of this application can be achieved. For example, the negative current collector may be copper foil, copper alloy foil, nickel foil, stainless steel foil, titanium foil, foamed nickel, foamed copper, a composite current collector (such as a lithium-copper composite current collector, a carbon-copper composite current collector, a nickel-copper composite current collector, or a titanium-copper composite current collector), or the like. In this case, both the first material layer and the second material layer are negative electrode material layers. The negative electrode material layer in this application includes a negative active material. The type of the negative active material is not particularly limited in this application, as long as the objectives of this application can be achieved. For example, the negative active material may include at least one of natural graphite, artificial graphite, mesocarbon microbeads (MCMB), hard carbon, soft carbon, silicon, a silicon-carbon composite, SiOx (0<x<2), Li—Sn alloy, Li—Sn—O alloy, Sn, SnO, SnO₂, spinel-structured lithium titanium oxide Li₄Ti₅O₁₂, Li—Al alloy, or metallic lithium. The thickness of the negative current collector is not particularly limited herein, as long as the objectives of this application can be achieved. Optionally, the negative electrode material layer may further include a conductive agent and a negative electrode binder. The type of the conductive agent in the negative electrode material layer is not particularly limited herein, as long as the objectives of this application can be achieved. For example, the type of the conductive agent may be the same as the conductive agent in the positive electrode material layer described above. The type of the negative electrode binder in the negative electrode material layer is not particularly limited herein, as long as the objectives of this application can be achieved. For example, the type of the negative electrode binder may be the same as the positive electrode binder in the positive electrode material layer described above. The mass ratio between the negative active material, the conductive agent, and the negative electrode binder in the negative electrode material layer is not particularly limited herein as long as the objectives of this application can be achieved.

The method for preparing the electrode plate is not particularly limited herein, as long as the objectives of this application can be achieved. For example, a preparation method of the electrode plate includes, but is not limited to, the following steps: (1) formulating a slurry; (2) applying the slurry onto one surface of the current collector, and oven-drying the current collector to form an electrode plate containing a first material layer; (3) applying the slurry onto the other surface of the current collector, and oven-drying the current collector to obtain an electrode plate containing the first material layer and a second material layer; and (4) determining a first section and a second section of the first material layer along the length direction of the electrode plate unwound and along the winding direction of the electrode assembly, providing protrusions on a surface of the first section, and performing cutting and slitting to obtain an electrode plate.

The solid content of the slurry is not particularly limited herein, and may be selected by a person skilled in the art as actually required, as long as the objectives of this application can be achieved. The process parameters of the oven-drying, cutting, and slitting are not particularly limited herein, and may be selected by a person skilled in the art as actually required, as long as the objectives of this application can be achieved. In one or more embodiments, in step (4), when the protrusions are provided on the surface of the first section, first recesses are provided on a surface of the second material layer toward the first material layer. In one or more embodiments, in step (4), when the protrusions are provided on the surface of the first section, the current collector is provided with second recesses toward the first material layer.

The methods for forming the protrusions, the first recesses, and the second recesses are not particularly limited herein, and may be selected by a person skilled in the art as actually required, as long as the objectives of this application can be achieved. An example of the methods is to use an embossing roller to cold-press the electrode plate to form the protrusions, the first recesses, and the second recesses. The shape of a projection of a single protrusion on the first material layer may be adjusted and controlled by adjusting the shape of stainless steel pins on the embossing roller. To the extent that the specifications of the electrode plates are the same, based on the projected area of the first section on the current collector, the proportion S of a sum of the projected areas of a plurality of protrusions on the first material layer may be adjusted and controlled by adjusting the number of stainless steel pins on the embossing roller, the number of revolutions the embossing roller makes during processing, and the length proportion L of the first section. The average height h₁ of a plurality of protrusions may be adjusted and controlled by adjusting a cold-pressing pressure value of the embossing roller or the height of the stainless steel pin on the embossing roller. The spacing A between two adjacent protrusions may be adjusted and controlled by adjusting the spacing between adjacent stainless steel pins on the embossing roller. The diameter D of the maximum circumcircle of the outer contour of the projection of a single protrusion on the first material layer may be adjusted and controlled by adjusting the specifications of the stainless steel pins on the embossing roller.

In one or more embodiments, the current collector includes a coated region coated with a material layer and a blank foil region connected to the coated region. At least a part of the blank foil region forms a flattened portion. The above arrangement makes it convenient to dispose tabs and process the secondary battery, and improves the safety performance and cycle performance of the columnar secondary battery.

The columnar secondary battery in this application includes an electrolyte solution. The electrolyte solution includes a lithium salt and a nonaqueous solvent. The lithium salt may include at least one of LiPF₆, LiNO₃, LiBF₄, LiCIO₄, LiB(C₆H₅)₄, LiCH₃SO₃, LiCF₃SO₃, LIN (SO₂CF₃)₂, LiC(SO₂CF₃)₃, Li₂SiF₆, lithium bis(oxalato) borate (LiBOB), lithium bis(trifluoromethanesulfonyl)imide (LiTFSI), or lithium difluoroborate. The content of the lithium salt in the electrolyte solution is not particularly limited herein, as long as the objectives of this application can be achieved. The nonaqueous solvent is not particularly limited herein, as long as the objectives of this application can be achieved. For example, the nonaqueous solvent includes, but is not limited to, at least one of a carbonate ester compound, a carboxylate ester compound, an ether compound, or other organic solvents. The carbonate ester compound may include, but is not limited to, at least one of a chain carbonate ester compound, a cyclic carbonate ester compound, or a fluorocarbonate ester compound. The chain carbonate ester compound may include, but is not limited to, at least one of dimethyl carbonate, diethyl carbonate, dipropyl carbonate, methyl propyl carbonate, ethylene propyl carbonate, or ethyl methyl carbonate. The cyclic carbonate ester compound may include, but is not limited to, at least one of ethylene carbonate, propylene carbonate (PC), butylene carbonate, or vinyl ethylene carbonate. The fluorocarbonate ester compound may include, but is not limited to, at least one of fluoroethylene carbonate, 1,2-difluoroethylene carbonate, 1,1-difluoroethylene carbonate, 1,1,2-trifluoroethylene carbonate, 1,1,2,2-tetrafluoroethylene carbonate, 1-fluoro-2-methyl ethylene, 1-fluoro-1-methyl ethylene carbonate, 1,2-difluoro-1-methyl ethylene carbonate, 1,1,2-trifluoro-2-methyl ethylene carbonate, or trifluoromethyl ethylene carbonate. The carboxylate ester compound may include, but is not limited to, at least one of methyl formate, methyl acetate, ethyl acetate, n-propyl acetate, tert-butyl acetate, methyl propionate, ethyl propionate, propyl propionate, γ-butyrolactone, decanolactone, valerolactone, or caprolactone. The ether compound may include, but is not limited to, at least one of dibutyl ether, tetraglyme, diglyme, 1,2-dimethoxyethane, 1,2-diethoxyethane, 1-ethoxy-1-methoxyethane, 2-methyltetrahydrofuran, or tetrahydrofuran. The above-mentioned other organic solvents may include, but are not limited to, at least one of dimethyl sulfoxide, 1,2-dioxolane, sulfolane, methyl sulfolane, 1,3-dimethyl-2-imidazolidinone, N-methyl-2-pyrrolidone, dimethylformamide, acetonitrile, trimethyl phosphate, triethyl phosphate, or trioctyl phosphate.

The separator is not particularly limited herein as long as the objectives of this application can be achieved. For example, the separator may be made of a material including, but not limited to, at least one of polyethylene (PE)-based, polypropylene (PP)-based polyolefin (PO) separator, polyester (such as polyethylene terephthalate (PET) film), cellulose, polyimide (PI), polyamide (PA), spandex, or aramid. The type of the separator may include a woven film, a nonwoven film, a microporous film, a composite film, a calendered film, or a spinning film. The separator of this application may assume a porous structure. The pore size of the porous structure of the separator is not particularly limited herein, as long as the objectives of this application can be achieved. For example, the pore size may be 0.01 μm to 1 μm. The thickness of the separator is not particularly limited herein, as long as the objectives of this application can be achieved. For example, the thickness of the separator may be 5 μm to 40 μm.

The columnar secondary battery of this application further includes a housing. The housing is configured to accommodate a positive electrode plate, a negative electrode plate, a separator, an electrolyte solution, and other components known in the art for use in a columnar secondary battery. Such other components are not limited herein. The housing is not particularly limited herein, and may be a housing well-known in the art, as long as the objectives of this application can be achieved.

The columnar secondary battery is not particularly limited herein, and may be any device in which an electrochemical reaction occurs. In one or more embodiments, the columnar secondary battery may be, but is not limited to, a lithium-ion secondary battery (lithium-ion battery), a lithium polymer secondary battery, a lithium-ion polymer secondary battery, or the like.

The method for preparing the columnar secondary battery is not particularly limited herein, and may be any preparation method well-known in the art, as long as the objectives of this application can be achieved. For example, a method for preparing the columnar secondary battery includes, but is not limited to, the following steps: stacking the separator, the negative electrode plate, the separator, and the positive electrode plate in sequence, and performing operations such as winding and folding as required on the stacked structure to obtain a jelly-roll electrode assembly; putting the electrode assembly into a housing, welding a current collector disk, assembling an insulation sheet, and then injecting an electrolyte solution into the housing, and sealing the housing to obtain a columnar secondary battery.

A second aspect of this application provides an electronic device. The electronic device includes the columnar secondary battery disclosed in any one of the preceding embodiments. The columnar secondary battery of this application exhibits good cycle performance. Therefore, the electronic device of this application possesses a relatively long service life.

The electronic device is not particularly limited herein, and may be any electronic device known in the prior art. For example, the electronic device may include, but is not limited to, a laptop computer, pen-inputting computer, mobile computer, e-book player, portable phone, portable fax machine, portable photocopier, portable printer, stereo headset, video recorder, liquid crystal display television set, handheld cleaner, portable CD player, mini CD-ROM, transceiver, electronic notepad, calculator, memory card, portable voice recorder, radio, backup power supply, motor, automobile, motorcycle, power-assisted bicycle, bicycle, lighting appliance, toy, game console, watch, electric tool, flashlight, camera, large household storage battery, or lithium-ion capacitor.

### EMBODIMENTS

The implementations of this application are described below in more detail with reference to some embodiments and comparative embodiments. Various tests and evaluations are performed by the following methods. In addition, unless otherwise specified, the word “parts” means parts by mass, and the symbol “%” means a percentage by mass.

### Test Methods and Devices

### Test of h₁, h₀, S, A, and D

Discharging a lithium-ion battery in each embodiment and comparative embodiment at a current of 0.5C at an ambient temperature of 25° C. until the voltage drops to 2.5 V, and then disassembling the battery to obtain an electrode assembly. Taking out a positive electrode plate and a negative electrode plate from the electrode assembly, soaking the electrode plates in dimethyl carbonate (DMC) for 20 minutes, and then drying the electrode plates in an oven at 80° C. for 12 hours to obtain test samples of the positive electrode plate and the negative electrode plate.

Observing the surface of an electrode plate by using a scanning electron microscope (SEM). To be specific, measuring a plane along the thickness direction of the electrode plate, where the plane is formed as a result of unwinding the electrode plate in the length direction and the width direction of the electrode plate unwound. Due to a height difference between the height of the protrusion itself and the surface of the material layer, a distinct contrast is visible on the surface of the electrode plate. A projection halo appears around each protrusion on the surface of the electrode plate and may be used to distinguish the protrusion from the first material layer. Selecting 5 halos randomly, and measuring the diameter of the maximum circumcircle of the outer contour of the projection of each halo on the first material layer. Averaging out the measured values to obtain the diameter D of the maximum circumcircle of the outer contour of the projection of a single protrusion. Selecting 10 halos randomly, and measuring the area of each halo. Averaging out the measured values to obtain the projected area of a single protrusion on the first material layer. Counting the number of halos on the electrode plate, which is the number of protrusions. Therefore, the sum of the projected areas of the protrusions on the first material layer=the projected area of a single protrusion on the first material layer×the number of protrusions. Measuring the width of the first material layer along the width direction of the electrode plate unwound. Measuring, along the length direction of the electrode plate unwound, the length of the first material layer provided with the protrusions. Therefore, the projected area of the first section on the current collector=the length of the first material layer provided with the protrusions×the width of the first material layer. S=the sum of the projected areas of the protrusions on the first material layer/the projected area of the first section on the current collector.

Polishing the electrode plate with the protrusions by using an ion beam cross-section polisher along the length and thickness directions of the electrode plate unwound, so as to obtain a cross-section of the electrode plate. Measuring the cross-section of the electrode plate by using a scanning electron microscope (SEM). A distinct dividing line is visible between the material layer and the current collector. The material layer provided with the protrusions is the first material layer. Selecting 5 protrusions randomly, measuring a maximum height from the surface of the first material layer to each protrusion along the thickness direction of the electrode plate, and averaging out the measured values to obtain an average height h₁ of a single protrusion. Measuring, along the thickness direction of the electrode plate, a distance from the surface of the first material layer to the surface of the current collector facing away from the first material layer, where the distance represents the sum h₀ of the thicknesses of the first material layer and the current collector. Selecting a protrusion randomly along the length direction of the negative electrode plate unwound, and measuring a distance between the geometric center of the protrusion and the geometric center of an adjacent protrusion for 5 times, and averaging out the measured values to obtain the spacing A between two adjacent protrusions.

### Cycle Performance Test

Performing a charge-and-discharge cycle test on a lithium-ion battery in each embodiment and comparative embodiment in a 25° C. thermostat. Charging the lithium-ion battery at a constant current of 2C until the voltage reaches 4.2 V, and then charging the battery at a constant voltage of 4.2 V until the current tapers off to 0.05C. Leaving the battery to stand for 5 minutes, and then discharging the battery at a constant current of 6C until the voltage drops to 2.5 V, thereby completing a first cycle. Recording the discharge capacity at this time as a first-cycle discharge capacity C₁. Repeating the above process for 600 cycles, and then recording the discharge capacity of the lithium-ion battery as C₆₀₀. Calculating the cycle capacity retention rate at the end of the 600^{th} cycle as a metric for evaluating the infiltration effect for the negative electrode plate and for evaluating the cycle performance of the lithium-ion battery. The calculation formula is Formula (I). A lower 600^{th}-cycle capacity retention rate indicates a worse infiltration effect for the negative electrode plate in the lithium-ion battery and lower cycle performance of the lithium-ion battery. A higher 600^{th}-cycle capacity retention rate indicates a better infiltration effect for the negative electrode plate in the lithium-ion battery and higher cycle performance of the lithium-ion battery.

$$60 {0}^{t h} - cycle capacity retention rate ( \% ) = {C}_{600} / {C}_{1} \times 100 \% . \qquad ( I ) .$$

### Computed Tomography and Test of an Inward Deformation Distance of an Electrode Plate

Performing a charge-and-discharge cycle test on a lithium-ion battery in each embodiment and comparative embodiment in a 25° C. thermostat. Charging the lithium-ion battery at a constant current of 2C until the voltage reaches 4.2 V, and then charging the battery at a constant voltage of 4.2 V until the current tapers off to 0.05C. Leaving the battery to stand for 5 minutes, and then discharging the battery at a constant current of 6C until the voltage drops to 2.5 V, thereby completing a first cycle. Repeating the above process for 600 cycles, and then disassembling the lithium-ion battery to obtain a jelly-roll electrode assembly.

Using industrial computed tomography (industrial CT, Zeiss Xradia 620 Versa) to perform CT scan on the jelly-roll electrode assembly along the width direction of the electrode assembly unwound (or along the axial direction of the electrode assembly), and measuring the distance from an innermost turn of the electrode assembly to an outermost turn at which the electrode plate is deformed, that is, the distance between a point M and a point N shown in FIG. 1, which is an inward deformation distance of the electrode plate.

### Embodiment 1

### Preparing a Positive Electrode Plate

Mixing lithium nickel cobalt manganese oxide (LiNi_{0.8}Co_{0.1}Mn_{0.1}O₂) as a positive active material, polyvinylidene fluoride (PVDF) as a binder, and conductive carbon black at a mass ratio of 94.8:2.8:2.4, and dispersing the constituents in an N-methyl-pyrrolidone (NMP) solvent. Stirring well to obtain a positive electrode slurry in which the solid content is 72 wt %. Coating one surface of 13 μm-thick positive current collector aluminum foil with the positive electrode slurry evenly, and drying the slurry at 105° C. to obtain a positive electrode plate coated with a first positive electrode material layer on a single side. Subsequently, repeating the above steps on the other surface of the positive current collector aluminum foil to obtain a positive electrode plate coated with the first positive electrode material layer and a second positive electrode material layer.

Determining a first section and a second section of the first positive electrode material layer along the length direction of the positive electrode plate unwound. Based on the length of the first positive electrode material layer, the length of the first section accounts for a proportion L of 12%, and the length of the second section accounts for a proportion L′ of 88%. Forming protrusions on the first section, the shape of the projection of a single protrusion on the first material layer is set to be circular along the thickness direction of the positive electrode plate. The diameter D of a maximum circumcircle of the outer contour of the projection of a single protrusion is 4 mm. Based on the projected area of the first section on the current collector, a sum of projected areas of the plurality of protrusions on the first material layer accounts for a proportion S of 40%. The average height h₁ of the plurality of protrusions is 10 μm. Along the length direction of the positive electrode plate unwound, the spacing A between two adjacent protrusions is 3.5 mm. Cold-pressing the positive electrode plate with an embossing roller of corresponding specifications according to the above parameters. Performing cutting and slitting to obtain a positive electrode plate provided with protrusions, first recesses, and second recesses. The coating weight of the first positive electrode material layer and the second positive electrode material layer is 234 mg/1540.25 mm². The specifications of the positive electrode plate are 64.5 mm×1422 mm. The specifications of the first positive electrode material layer are 60 mm×1422 mm. The specifications of the second positive electrode material layer are the same as the specifications of the first positive electrode material layer. The sum h₀ of the thicknesses of the first positive electrode material layer and the positive current collector is 50 μm. The width of the blank foil region of the positive electrode plate is 4.5 mm.

### Preparing a negative electrode plate

Mixing artificial graphite as a negative active material, sodium carboxymethyl cellulose (CMC-Na), and styrene-butadiene rubber (SBR) at a mass ratio of 97:1.7:1.3, and then adding deionized water as a solvent. Stirring well to obtain a negative electrode slurry in which the solid content is 50 wt %. Applying the negative electrode slurry evenly onto one surface of negative current collector copper foil with a thickness of 8 μm, and then drying the slurry at 105° C. to obtain a negative electrode plate coated with a first negative electrode material layer on a single side. Subsequently, repeating the above steps on the other surface of the negative current collector copper foil to obtain a negative electrode plate coated with both the first negative electrode material layer and a second negative electrode material layer. Subsequently, performing cold-pressing, cutting, and slitting to obtain a negative electrode plate of 67.45 mm×1436 mm in size ready for future use. The coating weight of the first negative electrode material layer and the second negative electrode material layer is 110 mg/1540.25 mm². The specifications of the first negative electrode material layer are 62 mm×1436 mm. The specifications of the second negative electrode material layer are the same as the specifications of the first negative electrode material layer. The sum of the thicknesses of the first negative electrode material layer and the negative current collector is 40 μm. The width of the blank foil region of the negative electrode plate is 5.45 mm.

### Separator

Using a 12 μm-thick polyethylene (PE) film as a separator.

### Preparing an Electrolyte Solution

Mixing ethylene carbonate (EC), ethyl methyl carbonate (EMC), and diethyl carbonate (DEC) at a mass ratio of 30:50:20 in an dry argon atmosphere glovebox to form an organic base solvent, and then adding hexafluorophosphate (LiPF₆) as a lithium salt into the base solvent, and stirring well to obtain an electrolyte solution. Based on the mass of the electrolyte solution, the mass percent of LiPF₆ is 12.5%, and the remainder is the base solvent.

### Preparing a Lithium-Ion Battery

Stacking the above-prepared separator, negative electrode plate, separator, and positive electrode plate sequentially, and pre-winding the stacked structure to ensure the following configurations: the separator is located between the negative electrode and the positive electrode; the first positive electrode material layer faces away from the center of the electrode assembly formed by the pre-winding; and the first section of the first positive electrode material layer is located near the center of the electrode assembly formed by the pre-winding. Subsequently, winding and flattening the stacked structure to form an electrode assembly, welding a current collector disk to the electrode assembly, placing the electrode assembly into a housing, performing penetration welding at the bottom of the housing, mark the product information on the housing by inkjet-printing, drying the housed electrode assembly in a vacuum, injecting an electrolyte solution, crimp-sealing the housing, leaving the product to stand in a high-temperature environment, and performing chemical formation and capacity grading to obtain a lithium-ion battery. The chemical formation is performed within an upper-limit voltage of 3.6 V at a temperature of 45° C., and the chemically formed product is left to stand at a normal temperature of 25° C. for 24 hours.

### Embodiments 2 to 29

Identical to Embodiment 1 except that the relevant preparation parameters are adjusted according to Table 1. When the sum h₀ of thicknesses of the first material layer and the current collector changes, the thickness of the current collector remains unchanged, and the coating weight is adjusted so that the value of h₀ complies with Table 1.

### Embodiment 30

Identical to Embodiment 1 except that the negative electrode plate and the lithium-ion battery are prepared according to the following steps:

### Preparing a Negative Electrode Plate

Mixing artificial graphite as a negative active material, sodium carboxymethyl cellulose (CMC-Na), and styrene-butadiene rubber (SBR) at a mass ratio of 97:1.7:1.3, and then adding deionized water as a solvent. Stirring well to obtain a negative electrode slurry in which the solid content is 50 wt %. Applying the negative electrode slurry evenly onto one surface of negative current collector copper foil with a thickness of 8 μm, and then drying the slurry at 105° C. to obtain a negative electrode plate coated with a first negative electrode material layer on a single side. Subsequently, repeating the above steps on the other surface of the negative current collector copper foil to obtain a negative electrode plate coated with both the first negative electrode material layer and a second negative electrode material layer.

Determining a first section and a second section of the first negative electrode material layer along the length direction of the negative electrode plate unwound. Based on the length of the first negative electrode material layer, the length of the first section accounts for a proportion L of 12%, and the length of the second section accounts for a proportion L′ of 88%. Forming protrusions on the first section, the shape of the projection of a single protrusion on the first material layer is set to be circular along the thickness direction of the negative electrode plate. The diameter D of a maximum circumcircle of the outer contour of the projection of a single protrusion is 4 mm. Based on the projected area of the first section on the current collector, a sum of projected areas of the plurality of protrusions on the first material layer accounts for a proportion S of 40%. The average height h₁ of the plurality of protrusions is 8 μm. Along the length direction of the negative electrode plate unwound, the spacing A between two adjacent protrusions is 3.5 mm. Cold-pressing the negative electrode plate with an embossing roller of corresponding specifications according to the above parameters. Performing cutting and slitting to obtain a negative electrode plate provided with protrusions, first recesses, and second recesses. The coating weight of the first negative electrode material layer and the second negative electrode material layer is 110 mg/1540.25 mm². The specifications of the negative electrode plate are 67.45 mm×1436 mm. The specifications of the first negative electrode material layer are 62 mm×1436 mm. The specifications of the second negative electrode material layer are the same as the specifications of the first negative electrode material layer. The sum h₀ of the thicknesses of the first negative electrode material layer and the negative current collector is 40 μm. The width of the blank foil region of the negative electrode plate is 5.45 mm.

### Preparing a Lithium-Ion Battery

Stacking the above-prepared separator, negative electrode plate, separator, and positive electrode plate sequentially, and pre-winding the stacked structure to ensure the following configurations: the separator is located between the negative electrode and the positive electrode; the first positive electrode material layer faces away from the center of the electrode assembly formed by the pre-winding; the first negative electrode material layer faces away from the center of the electrode assembly formed by the pre-winding; the first section of the first positive electrode material layer is located near the center of the electrode assembly formed by the pre-winding; and the first section of the first negative electrode material layer is located near the center of the electrode assembly formed by the pre-winding. Subsequently, winding and flattening the stacked structure to form an electrode assembly, welding a current collector disk to the electrode assembly, placing the electrode assembly into a housing, performing penetration welding at the bottom of the housing, mark the product information on the housing by inkjet-printing, drying the housed electrode assembly in a vacuum, injecting an electrolyte solution, crimp-sealing the housing, leaving the product to stand in a high-temperature environment, and performing chemical formation and capacity grading to obtain a lithium-ion battery. The chemical formation is performed within an upper-limit voltage of 3.6 V at a temperature of 45° C., and the chemically formed product is left to stand at a normal temperature of 25° C. for 24 hours.

### Comparative Embodiment 1

Identical to Embodiment 1 except that no protrusions are provided on the surface of the first material layer.

### Comparative Embodiment 2

Identical to Embodiment 1 except that the relevant preparation parameters are adjusted according to Table 1.

### Comparative Embodiment 3

Identical to Embodiment 1 except that the protrusions are provided on the surface of the first material layer.

### Comparative Embodiment 4

Identical to Embodiment 1 except that no protrusions are provided on the surface of the first section of the first material layer, protrusions are provided on the surface of the second section, and based on a projected area of the second section on the current collector, a sum of projected areas of the plurality of protrusions on the first material layer accounts for 40%.

The preparation parameters and performance parameters of each embodiment and comparative embodiment are shown in Table 1.

TABLE 1

| | | | | | | | | | Inward deformation | 600^{th}-cycle |
|---|---|---|---|---|---|---|---|---|---|---|
| | | | | | | | | | distance of | capacity |
| | L | L′ | h₀ | | h₁ | S | A | D | electrode | retention rate |
| | (%) | (%) | (μm) | h₁/h₀ | (μm) | (%) | (mm) | (mm) | plate (mm) | (%) |
| Embodiment 1 | 12 | 88 | 50 | 0.2 | 10 | 40 | 3.5 | 4 | 2 | 81.2 |
| Embodiment 2 | 2 | 98 | 50 | 0.2 | 10 | 40 | 3.5 | 4 | 3 | 80.1 |
| Embodiment 3 | 5 | 95 | 50 | 0.2 | 10 | 40 | 3.5 | 4 | 2.5 | 80.5 |
| Embodiment 4 | 18 | 82 | 50 | 0.2 | 10 | 40 | 3.5 | 4 | 1.5 | 81.8 |
| Embodiment 5 | 20 | 80 | 50 | 0.2 | 10 | 40 | 3.5 | 4 | 0.5 | 80.6 |
| Embodiment 6 | 12 | 88 | 35 | 0.2 | 7 | 40 | 3.5 | 4 | 1.8 | 81.5 |
| Embodiment 7 | 12 | 88 | 70 | 0.2 | 14 | 40 | 3.5 | 4 | 2.2 | 80.8 |
| Embodiment 8 | 12 | 88 | 50 | 0.02 | 1 | 40 | 3.5 | 4 | 3 | 78.9 |
| Embodiment 9 | 12 | 88 | 50 | 0.1 | 5 | 40 | 3.5 | 4 | 2.7 | 80.5 |
| Embodiment 10 | 12 | 88 | 50 | 0.3 | 15 | 40 | 3.5 | 4 | 1.8 | 81.9 |
| Embodiment 11 | 12 | 88 | 50 | 0.4 | 20 | 40 | 3.5 | 4 | 1.5 | 80.9 |
| Embodiment 12 | 12 | 88 | 50 | 0.45 | 22.5 | 40 | 3.5 | 4 | 1 | 79.6 |
| Embodiment 13 | 12 | 88 | 50 | 0.2 | 10 | 15 | 3.5 | 4 | 3 | 78.6 |
| Embodiment 14 | 12 | 88 | 50 | 0.2 | 10 | 25 | 3.5 | 4 | 2.7 | 80.9 |
| Embodiment 15 | 12 | 88 | 50 | 0.2 | 10 | 60 | 3.5 | 4 | 1.8 | 81.9 |
| Embodiment 16 | 12 | 88 | 50 | 0.2 | 10 | 70 | 3.5 | 4 | 1.5 | 79.9 |
| Embodiment 17 | 12 | 88 | 50 | 0.2 | 10 | 12 | 3.5 | 4 | 3.5 | 77.6 |
| Embodiment 18 | 12 | 88 | 50 | 0.2 | 10 | 75 | 3.5 | 4 | 0.2 | 78.1 |
| Embodiment 19 | 12 | 88 | 50 | 0.2 | 10 | 40 | 0.2 | 4 | 1 | 79.7 |
| Embodiment 20 | 12 | 88 | 50 | 0.2 | 10 | 40 | 1.5 | 4 | 1.5 | 81.8 |
| Embodiment 21 | 12 | 88 | 50 | 0.2 | 10 | 40 | 5 | 4 | 2.5 | 80.6 |
| Embodiment 22 | 12 | 88 | 50 | 0.2 | 10 | 40 | 10 | 4 | 2.8 | 78.6 |
| Embodiment 23 | 12 | 88 | 50 | 0.2 | 10 | 40 | 12 | 4 | 3 | 77.4 |
| Embodiment 24 | 12 | 88 | 50 | 0.2 | 10 | 40 | 3.5 | 0.5 | 2.8 | 79.7 |
| Embodiment 25 | 12 | 88 | 50 | 0.2 | 10 | 40 | 3.5 | 2 | 2.4 | 80.8 |
| Embodiment 26 | 12 | 88 | 50 | 0.2 | 10 | 40 | 3.5 | 6 | 1.8 | 81.8 |
| Embodiment 27 | 12 | 88 | 50 | 0.2 | 10 | 40 | 3.5 | 10 | 1.4 | 80.1 |
| Embodiment 28 | 12 | 88 | 50 | 0.2 | 10 | 40 | 3.5 | 0.3 | 3.1 | 79.1 |
| Embodiment 29 | 12 | 88 | 50 | 0.2 | 10 | 40 | 3.5 | 12 | 0.4 | 79.4 |
| Embodiment 30 | 12 | 88 | 40 | 0.2 | 8 | 40 | 3.5 | 4 | 0.3 | 82.6 |
| Comparative | 0 | 100 | 50 | / | / | / | / | / | 5 | 70.1 |
| Embodiment 1 | | | | | | | | | | |
| Comparative | 40 | 60 | 50 | 0.2 | 10 | 40 | 3.5 | 4 | 0.4 | 74.9 |
| Embodiment 2 | | | | | | | | | | |
| Comparative | 100 | 0 | 50 | 0.2 | 10 | 40 | 3.5 | 4 | 0.3 | 73.6 |
| Embodiment 3 | | | | | | | | | | |
| Comparative | 12 | 88 | 50 | 0.2 | 35 | / | 3.5 | 4 | 3.5 | 72.2 |
| Embodiment 4 | | | | | | | | | | |

Note:
“/” in Table 1 represents absence of the relevant preparation parameter.

As can be seen from Embodiments 1 to 30 and Comparative Embodiments 1 to 4, by providing the protrusions on only the surface of the first section of the first material layer and controlling the length of the first section to account for a proportion falling within the range specified herein, the inward deformation distance of the electrode plate is made short, and the 600^{th}-cycle capacity retention rate of the lithium-ion battery is increased, indicating that the lithium-ion battery of this application can effectively alleviate the inward deformation of the electrode plate at the inner turns of the electrode assembly caused by expansion of the electrode plate in the later stage of cycling and reduce the risk of lithium plating of the lithium-ion battery, so that the lithium-ion battery exhibits good cycle performance. In Comparative Embodiment 1, no protrusions are provided on the first material layer. In Comparative Embodiment 2, the length proportion L of the first section is outside the range specified herein. In Comparative Embodiment 3, the protrusions are provided on the first material layer. In Comparative Embodiment 4, the protrusions are provided on only the surface of the second section. Therefore, the inward deformation distance of the electrode plate of the lithium-ion batteries in Comparative Embodiments 1 to 4 is longer; and/or, the 600^{th}-cycle capacity retention rate is lower. By contrast, in Embodiments 1 to 30, the inward deformation distance of the electrode plate in the lithium-ion battery is short and the 600^{th}-cycle capacity retention rate is high, indicating that the degree of inward deformation of the electrode plate at the inner turns of the electrode assembly is low in the later stage of cycling, the risk of lithium plating of the lithium-ion battery is low, and the lithium-ion battery exhibits good cycle performance.

The values of h₁/h₀ and h₀ typically affect the cycle performance of the lithium-ion battery. As can be seen from Embodiment 1 and Embodiments 6 to 12, when the values of h₁/h₀ and h₀ fall within the ranges specified herein, the inward deformation distance of the electrode plate in the lithium-ion battery is short, and the 600^{th}-cycle capacity retention rate is high, indicating that the degree of inward deformation of the electrode plate at the inner turns of the electrode assembly is low in the later stage of cycling, the risk of lithium plating of the lithium-ion battery is low, and the lithium-ion battery exhibits good cycle performance.

The value of S typically affects the cycle performance of the lithium-ion battery. As can be seen from Embodiment 1 and Embodiments 13 to 18, when the value of S falls within the range specified herein, the inward deformation distance of the electrode plate in the lithium-ion battery is short and the 600^{th}-cycle capacity retention rate is high, indicating that the degree of inward deformation of the electrode plate at the inner turns of the electrode assembly is low in the later stage of cycling, the risk of lithium plating of the lithium-ion battery is low, and the lithium-ion battery exhibits good cycle performance.

The value of A typically affects the cycle performance of the lithium-ion battery. As can be seen from Embodiment 1 and Embodiments 19 to 23, when the value of A falls within the range specified herein, the inward deformation distance of the electrode plate in the lithium-ion battery is short, and the 600^{th}-cycle capacity retention rate is high, indicating that the degree of inward deformation of the electrode plate at the inner turns of the electrode assembly is low in the later stage of cycling, the risk of lithium plating of the lithium-ion battery is low, and the lithium-ion battery exhibits good cycle performance.

The value of D typically affects the cycle performance of the lithium-ion battery. As can be seen from Embodiment 1 and Embodiments 24 to 29, when the value of D falls within the range specified herein, the inward deformation distance of the electrode plate in the lithium-ion battery is short and the 600^{th}-cycle capacity retention rate is high, indicating that the degree of inward deformation of the electrode plate at the inner turns of the electrode assembly is low in the later stage of cycling, the risk of lithium plating of the lithium-ion battery is low, and the lithium-ion battery exhibits good cycle performance.

The electrode plate being a positive electrode plate and/or a negative electrode plate typically affects the cycle performance of the lithium-ion battery. As can be seen from Embodiments 1 and 30, when the electrode plate is a positive electrode plate and/or a negative electrode plate, the inward deformation distance of the electrode plate in the lithium-ion battery is short and the 600^{th}-cycle capacity retention rate is high, indicating that the degree of inward deformation of the electrode plate at the inner turns of the electrode assembly is low in the later stage of cycling, the risk of lithium plating of the lithium-ion battery is low, and the lithium-ion battery exhibits good cycle performance.

The presence or absence of the first recesses and/or the second recesses typically affects the cycle performance of the lithium-ion battery. As can be seen from Embodiments 1 to 30, when the first recesses and/or the second recesses are provided, the inward deformation distance of the electrode plate in the lithium-ion battery is short and the 600^{th}-cycle capacity retention rate is high, indicating that the degree of inward deformation of the electrode plate at the inner turns of the electrode assembly is low in the later stage of cycling, the risk of lithium plating of the lithium-ion battery is low, and the lithium-ion battery exhibits good cycle performance.

It is hereby noted that the relational terms herein such as “first” and “second” are used merely to differentiate one entity or operation from another, but do not involve or imply any actual relationship or sequence between the entities or operations. Moreover, the terms “include”, “comprise”, and any variation thereof are intended to cover a non-exclusive inclusion relationship by which a process, method, or object that includes or comprises a series of elements not only includes such elements, but also includes other elements not expressly specified or also includes inherent elements of the process, method, or object.

Different embodiments of this application are described in a correlative manner. For the same or similar part in one embodiment, reference may be made to another embodiment. Each embodiment focuses on differences from other embodiments.

Described above are merely preferred embodiments of this application that are not intended to limit this application. Any modifications, equivalent replacements, improvements, and the like made without departing from the concept and principles of this application still fall within the protection scope of this application.

What is claimed is:

1. A columnar secondary battery, comprising an electrode assembly, wherein the electrode assembly comprises an electrode plate, the electrode plate comprises a current collector and a first material layer, and the first material layer is located on a surface of the current collector facing away from a winding center of the electrode assembly;
along a length direction of the electrode plate and along a winding direction of the electrode assembly, the first material layer comprises a first section and a second section connected sequentially; and based on a length of the first material layer, a length of the first section accounts for a proportion of L, 2%≤L≤20%; and
a plurality of protrusions are formed on a surface of the first section alone on the electrode plate.

2. The columnar secondary battery according to claim 1, wherein, along a thickness direction of the electrode plate, an average height of the plurality of protrusions is h₁ μm, and a sum of thicknesses of the first material layer and the current collector is h₀ μm, 2%≤h₁/h₀×100%≤40%, and 35≤h₀≤70.

3. The columnar secondary battery according to claim 2, wherein 10%≤h₁/h₀×100%≤ 30%.

4. The columnar secondary battery according to claim 1, wherein 5%≤L≤18%.

5. The columnar secondary battery according to claim 1, wherein, along a thickness direction of the electrode plate, every protrusion is projected onto the first material layer to form a projection, and based on a projected area of the first section on the current collector, a sum of projected areas of the plurality of protrusions on the first material layer accounts for a proportion of S, 15%≤S≤70%.

6. The columnar secondary battery according to claim 5, wherein 25%≤S≤60%.

7. The columnar secondary battery according to claim 1, wherein, along the length direction of the electrode plate, a spacing between two adjacent protrusions is A mm, 0.2≤A≤10.

8. The columnar secondary battery according to claim 7, wherein 1.5≤A≤5.

9. The columnar secondary battery according to claim 7, wherein, along the length direction of the electrode plate, spacings between any two adjacent protrusions are equal.

10. The columnar secondary battery according to claim 5, wherein a diameter of a maximum circumcircle of an outer contour of a projection of a single protrusion is D mm, 0.5≤D≤10.

11. The columnar secondary battery according to claim 10, wherein 2≤D≤6.

12. The columnar secondary battery according to claim 1, wherein the electrode plate further comprises a second material layer, the second material layer is located on a surface of the current collector facing towards the winding center of the electrode assembly, and a surface of the second material layer is provided with a plurality of first recesses toward the first material layer.

13. The columnar secondary battery according to claim 12, wherein the current collector is provided with a plurality of second recesses toward the first material layer.

14. The columnar secondary battery according to claim 13, wherein at least a part of the first recesses correspond to a part of the protrusions; and/or, at least a part of the second recesses correspond to a part of the protrusions.

15. The columnar secondary battery according to claim 1, wherein the electrode plate is a positive electrode plate.

16. An electronic device, comprising a columnar secondary battery, the columnar secondary battery comprising an electrode assembly, wherein the electrode assembly comprises an electrode plate, the electrode plate comprises a current collector and a first material layer, and the first material layer is located on a surface of the current collector facing away from a winding center of the electrode assembly;
along a length direction of the electrode plate and along a winding direction of the electrode assembly, the first material layer comprises a first section and a second section connected sequentially, and based on a length of the first material layer, a length of the first section accounts for a proportion of L, 2%≤L≤20%; and
a plurality of protrusions are formed on a surface of the first section alone on the electrode plate.

17. The electronic device according to claim 16, wherein, along a thickness direction of the electrode plate, an average height of the plurality of protrusions is h₁ μm, and a sum of thicknesses of the first material layer and the current collector is h₀ μm, 2%<h₁/h₀×100%≤ 40%, and 35≤h₀≤70.

18. The electronic device according to claim 17, wherein 10%<h₁/h₀×100%≤30%.

19. The electronic device according to claim 16, wherein 5%≤L≤18%.

20. The electronic device according to claim 16, wherein, along a thickness direction of the electrode plate, every protrusion is projected onto the first material layer to form a projection, and based on a projected area of the first section on the current collector, a sum of projected areas of the plurality of protrusions on the first material layer accounts for a proportion of S, 15%≤S≤70%.
